(19) United States
(12) Patent Application Publication
(10) Pub. No.: US 2015/0289186 A1
(43) Pub. Date: Oct. 8, 2015

(54) ENTITY AND A METHOD OF OPERATING AN ENTITY OF A WIRELESS LOCAL AREA NETWORK

(71) Applicant: OPTIS WIRELESS TECHNOLOGY ,LLC, Plano, TX (US)

(72) Inventors: Per-Daniel Stålnacke, Bromma (SE); Tomas Nylander, Varmdo (SE); Jari Tapio Vikberg, Jarna (SE)

(73) Assignee: Optis Cellular Technology ,LLC. a corporation

(21) Appl. No.: 14/441,267

(22) PCT Filed: Nov. 8, 2012
(86) PCT No.: PCT/EP2012/072201

§ 371 Date: May 7, 2015

(51) Int. Cl. H04W 36/22; H04W 84/04; H04W 24/08; H04W 84/12

(52) U.S. Cl. CPC H04W 36/22; H04W 84/12; H04W 84/042; H04W 24/08

(57) ABSTRACT

The present invention provides an entity of a Wireless Local Area Network, WLAN, such as a WLAN access point or access controller. The entity includes a processor configured to obtain load information for a cellular mobile network in response to a request for load information received from a device which is not associated with the WLAN. The entity also includes a transmitter configured to transmit the obtained load information to the device. The invention also provides a device such as a cellular phone capable of connecting to a cellular mobile network and associating with a WLAN. The device includes a transmitter, a receiver and a processor. The transmitter can transmit a request for load information about a cellular mobile network to an entity of a Wireless Local Area Network when the device is not associated with the WLAN. The receiver can receive the load information. The processor determines whether to associate with the WLAN using the load information.

### TECHNICAL FIELD

The present invention relates to an entity, and a method of operating an entity of a Wireless local Area Network (WLAN), and in particular a Wi-Fi network. More particularly, the invention relates to an entity of a WLAN and a method of operating an entity of a WLAN for providing load information associated with a cellular mobile network to a device that is not associated with the WLAN.

### BACKGROUND

Data traffic in mobile telecommunications networks is continually increasing. Consequently, operators are employing heterogeneous access networks that utilise multiple radio access technologies (RATs) in order to provide greater capacity, particularly in high traffic areas and areas that otherwise have poor network coverage.

Typically, the radio access technologies utilised as part of these heterogeneous access networks include UMTS Radio Access Network (UTRAN) and an Evolved UTRAN (E-UTRAN), and Wi-Fi/WLAN. For example, FIG. 1 illustrates schematically a simplified example of a heterogeneous network 1 that comprises a 3GPP RAN 2 and a Wi-Fi RAN 3 suitable for implementing the methods described herein. The 3GPP RAN 2 includes a number of 3GPP radio nodes 4. For example, if the 3GPP RAN was a UTRAN, then these radio nodes would be NodeBs and Radio Network Controllers (RNC). By way of further example, if the 3GPP RAN was an E-UTRAN, then these radio nodes would be eNodeBs. The 3GPP RAN 2 is connected to a mobile core network 5. The Wi-Fi RAN 3 includes a number of Wi-Fi/WLAN APs 7 that can be connected to a Wi-Fi/WLAN Access Controller (AC) 8. The Wi-Fi/WLAN AC 8 can control each of the Wi-Fi/WLAN APs 7 and assists in authentication of a mobile station/user terminal that wants to associate with/attach to the Wi-Fi RAN/WLAN 3.

If the heterogeneous access network comprises a UTRAN, an E-UTRAN, and a Wi-Fi RAN/WLAN then both the UTRAN and E-UTRAN standards are defined by the 3rd Generation Partnership Project (3GPP), and the relevant 3GPP standards therefore define capabilities for handling load sharing between these 3GPP RANs. In contrast, the Wi-Fi/WLAN standards are defined by the Institute of Electrical and Electronics Engineers (IEEE), and neither the IEEE standards nor the 3GPP standards define capabilities for handling load sharing between Wi-Fi/WLAN and the 3GPP RANs.

In particular, for most currently available devices, i.e. user equipments (UE) or a client device, when the device is within the coverage of both a Wi-Fi RAN/WLAN and a 3GPP RAN, the device will automatically attempt to connect to the Wi-Fi RAN/WLAN and will detach from the 3GPP RAN. Therefore, the decision to move from the 3GPP RAN to the WLAN is made without having considered the load and/or performance of either RAN, and can result in a reduction in performance that is detrimental to both the networks and the user.

In order to provide at least some form of load steering between a Wi-Fi RAN/WLAN and a 3GPP RAN, it is currently being proposed that when a device attempts to associate with the Wi-Fi RAN/WLAN, any relevant conditions of both the WLAN and the 3GPP RAN are evaluated and it is thereby determined whether the device should use the Wi-Fi RAN/WLAN or an available 3GPP RAN. However, as the user equipment identifiers used in the Wi-Fi RAN/WLAN and the 3GPP RAN are different evaluating the relevant conditions of the Wi-Fi RAN/WLAN and the 3GPP RAN is not a simple operation.

### SUMMARY

According to an aspect of the present invention there is provided a method of operating an entity of a Wireless Local Area Network, WLAN. The method includes the steps of the entity of the WLAN receiving a request for load information about a cellular mobile network from a device which is not associated with the WLAN. In response to the request the entity obtains the load information and transmits the load information to the device. This allows the device to determine whether it is advantageous to associate with the WLAN or not.

Optionally, the request may include a public land mobile network, PLMN identifier, and the entity when obtaining the load information determines, from the PLMN identifier, a cell of the cellular mobile network which has overlapping coverage with the WLAN access point; and obtains load information for the cell. This allows the WLAN entity to provide information to the device in order for it to determine whether to associate with the WLAN or connect to/camp on the cellular mobile network as it then has access to the load information for the cellular mobile network.

Alternatively, the request may include the identity of a cell in the cellular mobile network. By including the identity of the cell the entity of the WLAN may obtain load information for the identified cell. This is of particular use, for example, if the device is already connected to or camping on the cellular mobile network and knows the identity of the cell to which it is connected to or camping on as it enables the WLAN to more efficiently obtain the required information about the cellular mobile network.

The load information may be obtained by the entity in the WLAN transmitting, to an entity in the cellular mobile network, a request for load information and receiving load information for the cellular mobile network. This enables the device to obtain up to date load information for the cellular mobile network.

Alternatively, the entity of the WLAN may store load information relating to the cellular mobile network in a memory and, in response to the request, obtain load information by retrieving the load information from the memory. The WLAN may request that the 3GPP network provides it with load information to be stored in the memory periodically for each cell or when a load threshold within the 3GPP network has been passed. This enables the entity of the WLAN to provide the load information to the device quickly.

The request for load information may include a request for load information for at least a part of the WLAN and a request for load information for the cellular mobile network.

The load information may be one or more of the access point load, the backhaul load, air interface load, 3GPP RAN Node load and the network processing load.

According to another aspect of the present invention there is provided an entity of a Wireless Local Area Network, WLAN. The entity includes a processor and a transmitter. The processor is able to obtain load information for a cellular mobile network in response to a request for load information received from a device which is not associated with the WLAN. The transmitter is able to transmit the obtained load information to the device.

The request may include a public land mobile network, PLMN, identifier in which case the processor is able to obtain load information by determining, from the PLMN identifier, a cell of the cellular mobile network having overlapping coverage with the entity of the WLAN and obtaining load information for the cell.

Alternatively, the request may include the identity of a cell in the cellular mobile network. In such a case the entity of the WLAN obtains load information for the identified cell.

The processor may be able to cause the transmitter to transmit a request for load information to an entity in a cellular mobile network and include a receiver to receive load information from an entity in the cellular mobile network.

The entity may include a memory configured to store load information relating to the cell of the cellular mobile network. In such a case the processor obtains the load information by retrieving the load information from the memory.

The request for load information may include a request for load information for at least part of the WLAN and a request for load information for the cellular mobile network.

The load information requested and/or retrieved may be one or more of the access point load, the backhaul load air interface load, 3GPP RAN Node load and the network processing load.

The entity of a Wireless Local Area Network may be a WLAN access point or a WLAN Access Controller (WLAN AC).

According to a further aspect of the present invention there is provided a method of operating a device capable of connecting to or camping on a cellular mobile network and associating with a WLAN. The method includes transmitting a request for load information about a cellular mobile network to an entity of a Wireless Local Area Network, WLAN, when the device is not associated with the WLAN. In response to the request for load information the device receives the load information and uses the load information to determine whether to connect to/camp on the cellular mobile network or associate with the WLAN. In this way the device may be able to determine whether a connection to the cellular mobile network or an association with the WLAN provides better service and therefore can select between the cellular mobile network and the WLAN.

The request may include a public land mobile network, PLMN, identifier or alternatively, the request may include the identity of a cell in the cellular mobile network. Where the request includes the identity of a cell the load information received by the device is load information relating to the identified cell.

According to yet another aspect of the present invention there is provided a device capable of connecting to or camping on a cellular mobile network and associating with a WLAN. The device includes a transmitter, a receiver and a processor. The transmitter transmits a request for load information about a cellular mobile network to an entity of a Wireless Local Area Network when the device is not associated with the WLAN. The receiver acts to receives the load information. The processor is able to determine whether to connect to or camping on the cellular mobile network or associating with the WLAN using the load information.

The request transmitted by the device may include the identity of a PLMN to which the device may connect. Alternatively, the request may include the identity of a cell in the cellular mobile network.

### BRIEF DESCRIPTION OF THE DRAWINGS

Some embodiments of the present invention will now be described in detail with reference to the accompanying drawings, in which:

FIG. 1 illustrates schematically an example of a heterogeneous access network;

FIG. 2 illustrates schematically an embodiment of a WLAN entity configured to implement the methods described herein;

FIG. 3 illustrates schematically an embodiment of a device configured to implement the methods described herein;

FIG. 4 is a flow diagram illustrating an example of the procedure of user equipment (UE) obtaining load information for both a WLAN and a 3GPP network in accordance with the methods described herein; and

FIG. 5 is a flow diagram illustrating an alternative example of the procedure user equipment (UE) obtaining load information for both a WLAN and a 3GPP network in accordance with the methods described herein.

### DETAILED DESCRIPTION

There will now be described a method enabling user equipment to determine whether to associate with an Access Point (AP) of a Wireless Local Area Network (WLAN) or connect to or camp on a cell of a 3GPP network including at least one 3GPP RAN, such as a UTRAN or E-UTRAN, when an area covered by a WLAN AP overlaps with a cell of a 3GPP network.

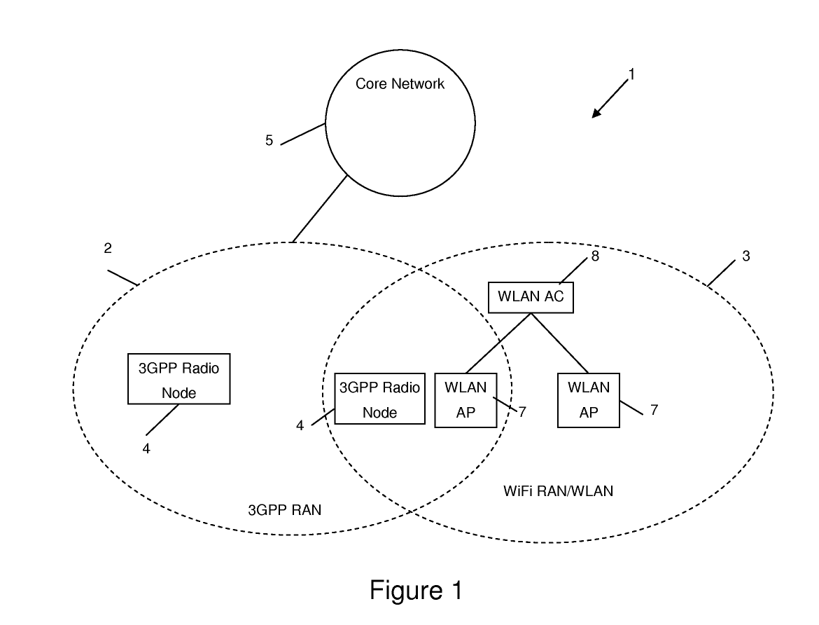

The 3GPP network, as illustrated in FIG. 1, may be any radio access network where the standards are defined by the 3rd Generation Partnership Project (3GPP). For example, the 3GPP network may be a Universal Mobile Telecommunications System (UMTS) or a Long Term Evolution (LTE) System.

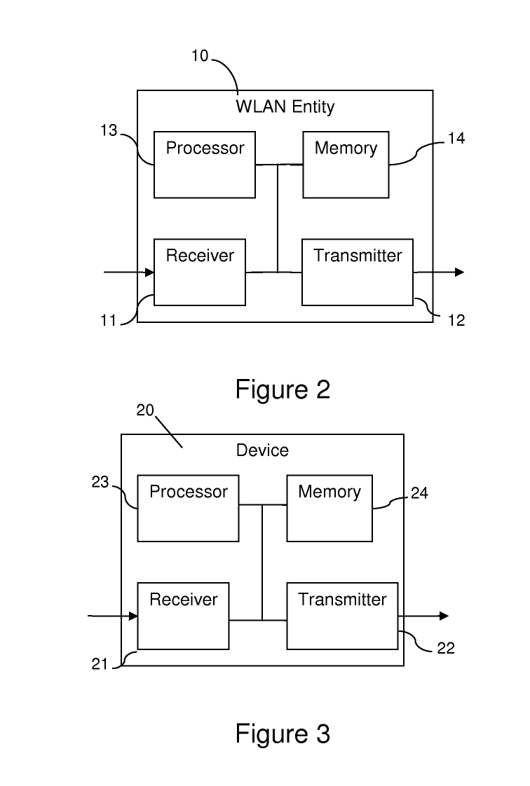

The WLAN network which may be a Wi-Fi network, as illustrated in FIG. 1, is a radio access network with standards defined by the Institute of Electrical and Electronics Engineers (IEEE). FIG. 2 illustrates schematically an embodiment of an entity of a WLAN 10 configured to implement the methods described below. The WLAN entity 10 can be implemented as a combination of computer hardware and software and comprises a receiver 11, a transmitter 12, a processor 13, and a memory 14. The memory 14 stores the various programs/executable files that are implemented by the processor 13, and also provides a storage unit for any required data. For example, the memory 14 can store one or more identities of cells which overlap with the coverage of the WLAN access point. The programs/executable files stored in the memory 14, and implemented by the processor 13, include but are not limited to a load and/or performance monitoring and reporting unit and an activity notification unit that implement the methods described below. The WLAN network may, optionally, be connected to the core network illustrated in FIG. 1.

FIG. 3 illustrates schematically an embodiment of a device 20 configured to implement the methods described below. The device 20 can be implemented as a combination of computer hardware and software and comprises a receiver 21, a transmitter 22, a processor 23, and a memory 24. The memory 24 stores the various programs/executable files that are implemented by the processor 23, and also provides a storage unit for any required data. For example, the memory 24 can store the identity of the 3GPP cell the device is connected to or camping on. The programs/executable files stored in the memory 24, and implemented by the processor 23, include but are not limited to determining whether to associate with the WLAN AP or connect to the 3GPP cell. The device may be, for example, a user equipment (UE), a mobile telephone, a tablet computing device or a laptop.

The method involves user equipment obtaining load information relating to both a WLAN AP and a 3GPP cell where the coverage of the WLAN AP and the 3GPP cell overlap.

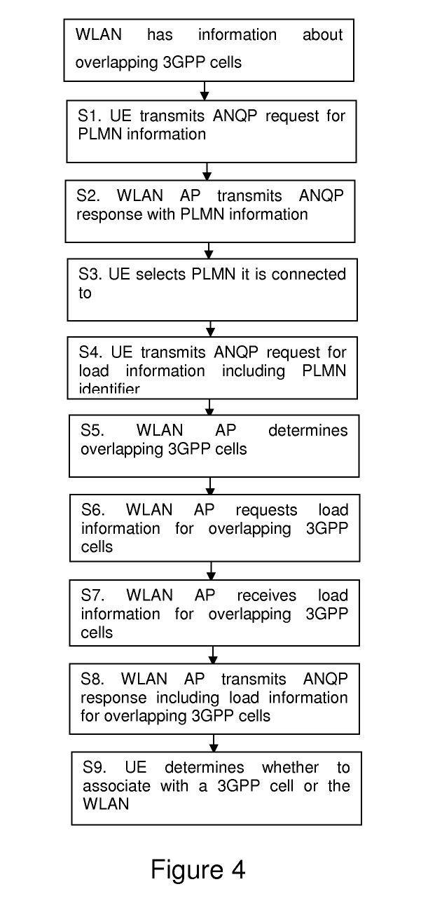

A first embodiment of the invention will now be described with reference to FIG. 4. In this embodiment the WLAN AP nodes are provided with information about cells in the 3GPP network which overlap with the area covered by a WLAN AP. One method of providing the nodes with this information is described in PCT/EP2012/065970 which is incorporated herein by reference.

FIG. 4 illustrates an example flow diagram of an implementation of the methods described herein. The steps performed are as follows:
S1. a UE transmits an Access Network Query Protocol (ANQP) request to request Public Land Mobile Network (PLMN) information from the WLAN AP.
S2. The WLAN responds to the request with a list of PLMNs to which it is connected.
S3. The UE selects the PLMN in the received list which it is connected to in the 3GPP network.
S4. The user equipment transmits an ANQP request to the WLAN AP including the identifier of the selected PLMN. The user equipment also includes, within the ANQP request, a request for load information for 3GPP cells belonging to the selected PLMN.
S5. The WLAN AP determines which cells of the 3GPP network overlap with its coverage area.
S6. The WLAN AP requests the loads in those cells from the 3GPP system for example using the method described in PCT/EP/2012/065970.
S7. The 3GPP system responds to the request with load information about the cells.

The load information may be 3GPP RAN Node load information, backhaul load information or any other suitable information relating to load on the 3GPP cell and any connections between nodes in the 3GPP network.
S8. The WLAN responds to the user equipment request, the response including information regarding the overlapping 3GPP cells and load information relating to the 3GPP cells.
S9. The user equipment determines from the received load information whether to associate with the WLAN AP or remain connected to/camping on the 3GPP network.

Rather than querying the 3GPP network for load information the WLAN AP, or another WLAN entity, may request that the 3GPP network provides it with load information to be stored in the memory periodically for each cell or when a load threshold within the 3GPP network has been passed. Additionally, the WLAN AP, or another WLAN entity, may have a list of 3GPP cells which overlap with the coverage of the WLAN AP stored in its memory. Thus, this information may be retrieved from the memory of the WLAN AP or the other WLAN entity, rather than by querying the 3GPP network.

Optionally, the device may determine a plurality of networks identified by different PLMNs to which can service it. In such a case the device selects one of these PLMNs and provides the identity of that PLMN to the WLAN AP as described above.

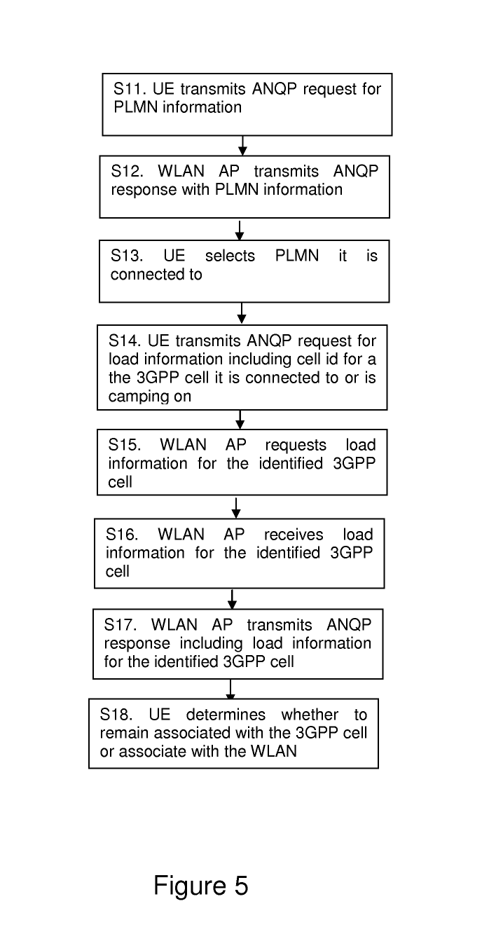

FIG. 5 illustrates a signalling flow diagram of an alternative implementation of the methods described herein. The steps performed are as follows:
S11. A UE transmits an ANQP request to the WLAN AP to request PLMN information from the WLAN AP.
S12. The WLAN AP responds to this request with a list of PLMNs for which it provides a service.
S13. The UE determines that the PLMN of the current 3GPP cell (i.e. the 3GPP cell that the UE is either connected to or is camping on) is part of the PLMN list received.
S14. The UE transmits an ANQP request to request load information for the 3GPP network to the WLAN AP. The request includes the identifier of a 3GPP cell to which the user equipment is connected to or is camping on.
S15. The WLAN AP requests load information for the cell identified in the ANQP request from the 3GPP network.
S16. The 3GPP network responds to the request from the WLAN AP with load information about the identified cell. As discussed above the load information may be 3GPP RAN node load information, backhaul load information or any other suitable information relating to the load on a 3GPP cell or in a part of the 3GPP network.
S17. Upon receiving the load information the WLAN AP transmits a response to the user equipment's request, the response includes load information for the cell identified in the ANQP request transmitted by the user equipment.
S18. The user equipment determines, from the received load information, whether to associate with the WLAN AP or remain connected to/camping on the 3GPP cell.

The skilled person will understand that although the method above indicates that the request for load information is sent after PLMN information is received from the WLAN AP the user equipment may send the request for load information at any point in the sequence. For example, the user equipment may transmit the identity of the 3GPP cell it is connected to or camping on with before or concurrently with requesting the PLMN list thereby omitting steps S11 to S13 above. The UE may also request load information for the 3GPP cell to which the user equipment is connected to be sent before or concurrently with the request for PLMN information.

Additionally, as described above, the WLAN AP, or another WLAN entity, may have load information for cells of the 3GPP network stored in a memory and, therefore, this information may be retrieved from the memory of the WLAN AP or another WLAN entity rather than querying the 3GPP network.

The WLAN AP may also provide load information for the WLAN. The load information may relate to the load associated with the AP or the load associated with the extended service set (ESS) which includes the AP. The load information may be access point load information, backhaul load information or any other suitable information relating to load in the WLAN or a part of the WLAN. The load information for the WLAN may be provided in the same message as the message providing load information for one or more cells of the 3GPP network or separately.

Although the present invention has been described with reference to determining whether to leave a 3GPP cell and connect to a WLAN AP the method is equally applicable for enabling user equipment to determine whether to associate with a WLAN AP or connect to or camp on a 3GPP cell in the absence of a connection to either.

Further, although the requests for load information and responses including load information have been described as being sent using the ANQP protocol it will be understood by the skilled person that any suitable protocol may be used to transmit messages between the user equipment and the WLAN AP.

Additionally, in the message providing the identifier of the selected PLMN or a 3GPP cell the UE may also include further details regarding the capability of the UE. For example, the message may include information about radio access technologies (GSM, WCDMA, LTE etc. . . . ) which the UE supports. The message may also include information about which radio frequency bands the UE supports. This information can be used by the WLAN to narrow down which 3GPP cells the load information is retrieved from and basing this decision on which 3GPP cells the UE would be capable of accessing. In the case the UE includes information about a 3GPP cell, this included information may comprise also information about which radio access technology the 3GPP cell belongs to. For the purposes of this application wireless capability is considered to include any information regarding the UE which the WLAN AP may use to determine which 3GPP cells the UE may connect to.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. For example, in the example flow diagrams described above, only those messages that are of particular relevance are discussed. Those skilled in the art will be aware of those messages that have not been included in this illustration. In addition, whilst the above described embodiments specifically relate to heterogeneous networks comprised of at least a 3GPP network and a WLAN, the principles of the methods described herein are equally applicable to heterogeneous networks that comprise other radio access technologies; such as cdmaOne and CDMA2000.

For the purposes of this document cellular mobile network is considered to refer to any network which comprises a radio access technology other than WLAN. For example, it may comprise a UTRAN, an E-UTRAN a cdmaOne network or CDMA2000 network.

1. A method of operating an entity of a Wireless Local Area Network, WLAN, the method comprising:
receiving a request for load information about a cellular mobile network from a device which is not associated with the WLAN;
obtaining the load information; and
transmitting the load information to the device.

2. The method as claimed in claim 1 wherein
the request includes a public land mobile network, PLMN, identifier;
obtaining the load information comprises determining, from the PLMN identifier, a cell of the cellular mobile network which has overlapping coverage with the WLAN access point; and obtaining load information for the cell.

3. The method as claimed in claim 2 wherein the request further comprises information regarding the wireless capability of the device and determining a cell of the cellular mobile network includes using the information to determine one or more cells of the cellular mobile network which can associate with the device.

4. The method as claimed in claim 1 wherein
the request includes the identity of a cell in the cellular mobile network; obtaining the load information comprises obtaining load information for the identified cell.

5. The method as claimed in claim 1 wherein obtaining the load information comprises
transmitting, to an entity in the cellular mobile network, a request for load information; and
receiving load information for the cellular mobile network.

6. The method as claimed in claim 1 wherein the method further comprises the entity of the WLAN storing, in a memory, the load information relating to the cellular mobile network wherein the step of obtaining load information comprises retrieving load information from the memory.

7. The method as claimed in claim 1 wherein the request for load information includes a request for load information for at least a part of the WLAN and a request for load information for the cellular mobile network.

8. The method as claimed in claim 1 wherein the load information comprises one or more of the access point load, the backhaul load, air interface load, 3GPP RAN node load and the network processing load.

9. An entity of a Wireless Local Area Network, WLAN, comprising:
a processor configured to obtain load information for a cellular mobile network in response to a request for load information received from a device which is not associated with the WLAN; and
a transmitter configured to transmit the obtained load information to the device.

10. An entity of a Wireless Local Area Network as claimed in claim 9 wherein the request includes a public land mobile network, PLMN, identifier; and the entity is configured to obtain load information by determining, from the PLMN identifier, a cell of the cellular mobile network having overlapping coverage with the entity of the WLAN and obtaining load information for the cell.

11. An entity of a Wireless Local Area Network as claimed in claim 10 wherein the request further comprises information regarding the wireless capability of the device and the entity is further configured to determine a cell of the cellular mobile network by using the information to determine one or more cells of the cellular mobile network which can associate with the device.

12. An entity of a Wireless Local Area Network as claimed in claim 9 wherein the request includes the identity of a cell in the cellular mobile network; and obtaining the load information comprises obtaining load information for the identified cell.

13. An entity of a Wireless Local Area Network as claimed in claim 9 wherein the entity is configured to obtain load information by the processor causing the transmitter to transmit a request for load information to an entity in a cellular mobile network; the entity including a receiver operable to receive load information from an entity in the cellular mobile network.

14. An entity of a Wireless Local Area Network as claimed in claim 9 wherein the entity further comprises a memory configured to store load information relating to the cell of the cellular mobile network and obtaining the load information comprises retrieving the load information from the memory.

15. An entity of a Wireless Local Area Network as claimed in claim 9 wherein the request for load information includes a request for load information for at least part of the WLAN and a request for load information for the cellular mobile network.

16. An entity of a Wireless Local Area Network as claimed in claim 9 wherein the load information comprises one or more of the access point load, the backhaul load air interface load, 3GPP RAN node load and the network processing load.

17. An entity of a Wireless Local Area Network as claimed in claim 9 wherein the entity comprises a WLAN access point or a WLAN Access Controller.

18. A method of operating a device capable of connecting to a cellular mobile network and associating with a WLAN, the method comprising:
transmitting a request for load information about a cellular mobile network to an entity of a Wireless Local Area Network, WLAN, when the device is not associated with the WLAN;
receiving the load information; and
using the load information to determine whether to associate with the WLAN.

19. A method of operating a device as claimed in claim 18 wherein the request includes a public land mobile network, PLMN, identifier.

20. A method of operating a device as claimed in claim 18 wherein the request further includes information relating to a wireless capability of the device.

21. A method of operating a device as claimed in claim 18 wherein the request includes the identity of a cell in the cellular mobile network; and the load information is load information relating to the identified cell.

22. A device capable of connecting to a cellular mobile network and associating with a WLAN, the device comprising:
a transmitter operable to transmit a request for load information about a cellular mobile network to an entity of a Wireless Local Area Network when the device is not associated with the WLAN;
a receiver operable to receive the load information; and
a processor operable to determine whether to associate with the WLAN using the load information.

23. A device as claimed in claim 22 wherein the request includes the identity of a PLMN.

24. A device as claimed in claim 22 wherein the request further includes information relating to a wireless capability of the device.

25. A device as claimed in claim 22 wherein the request includes the identity of a cell in the cellular mobile network.
